(19) United States
(12) Patent Application Publication
(10) Pub. No.: US 2014/0291236 A1
(43) Pub. Date: Oct. 2, 2014

(54) Multifunction Strainer and Bowl

(71) Applicant: Scott Thomas, Fairfield, CA (US)

(72) Inventor: Scott Thomas, Fairfield, CA (US)

(21) Appl. No.: 13/850,333

(22) Filed: Mar. 26, 2013

(51) Int. Cl. A47J 19/00

(52) U.S. Cl. CPC A47J 19/005
USPC 210/482

(57) ABSTRACT

Disclosed is a multifunction strainer and bowl apparatus comprised of a generic structure bowl with a colander strainer inset at the bottom of the bowl. A hollow base extends from the base of the bowl and allows communication of fluids therethrough from the bowl and through the strainer. A bottom cap threadably connects to the hollow base for sealing the hollow base and preventing contents from draining from the bowl. A lid seals around an upper lip of the bowl to seal the bowl interior volume. The colander screen internal to the bowl is located along the bottom of the bowl and above the hollow base. The hollow base below the colander screen comprises a cylindrical shell, whereby liquid drains through the colander screen from the bowl and through the base.

### BACKGROUND OF THE INVENTION

1. Field of the Invention

The present invention relates to food preparation and food service. More specifically, the present invention pertains to a multifunction strainer and bowl apparatus that allows solid and/or liquid food products to be stored or transported, and optionally strained of liquid by removal of a threaded base, which exposes an internal strainer screen within the bowl to communicate liquid therethrough without a separate intermediate vessel and without spilling the solid food contents.

Washing, straining, storage, transportation and serving of food products usually requires multiple vessels with one specific use. Colanders and strainers naturally separate liquids from solid food products, but are not suited for storage, designed without a sealing lid and allowing air and contaminants to pass through strainer apertures, allowing for spoilage over time.

Generic bowls can be used to perform washing or rinsing of food products, but require tipping of the vessel to remove liquids, wherein food products may also be accidentally removed. Additionally, since the tipping of the bowl is generally a temporary action, compared to the continual straining offered by a colander, very often not all of the water is removed. Many bowls are not designed with a lip which allows for attachment of a lid for secure storage, relying on third party products such as cellophane to create an air tight seal.

Maintenance and preparation of colander and bowl serving sets can be time-consuming, requiring separating and cleaning large components. Additionally, the individual components of a colander and bowl set present limited functionality or utility when implemented alone. Convertible or selectable strainers often have unreliable sealing mechanisms that can be accidentally actuated, improperly sealed by the user, or fouled by particles strained from the inner volume. Convertible and selectable strainers also present difficulties when cleaning, requiring the separation of moving parts and, in some cases, hand washing to remove any fouling particles.

The present invention attempts to provide one integrated vessel that performs a multitude of common kitchen tasks including simple straining, storage and transport of solids and liquids in solution, and serving of freshly strained and straining items.

2. Description of the Prior Art

Devices have been disclosed in the prior art that relate to the straining and service of food products. These include devices that that have been patented and published in patent application publications. These devices generally relate to strainers or colanders that attach to a dedicated serving bowl for the purpose of serving or storing recently strained or currently draining food products, as well as selectable strainer devices, which allow for straining in one configuration and serving in another, often determined by rotation. The devices deemed most relevant to the present disclosure are herein described for the purpose of highlighting and differentiating the unique aspects of the present invention, and further highlighting the drawbacks existing in the prior art.

Specifically, U.S. Pat. No. 6,949,190 to Hutzler describes a device for washing, serving, and storing perishable food products. The Hutzler device is comprised of a nesting set of a colander and bowl, where the smaller, internally nesting colander includes a raised hollow base, allowing for water to drain from the food product into the larger exterior bowl. While the Hutzler device pursues similar goals, the present invention integrates the bowl and strainer in a single device, requiring less cleaning of large components.

U.S. Pat. No. 7,422,120 to Fried describes a colander bowl and serving set comprised of three pieces: an inner strainer, a movable sealing plate, and an outer bowl with a central hole. By rotating the movable sealing plate, the colander is raised and lowered in to be in contact with the outer bowl. At the raised position, water drains through the colander and the central hole in the outer bowl. In the lowered position, the colander is flush with the bowl, preventing drainage. The Fried device integrates a colander and bowl for service, but does not allow for a lid for long term storage. Additionally, the seal between the inner strainer and outer bowl is maintained only by gravity, potentially allowing water to seep out when not intended, allowing for unintended release and resulting spillage.

U.S. Pat. No. 7,467,718 granted to Donohue describes a combination strainer and service bowl comprised of a strainer with a base allowing for drainage and threaded on the outside that can be screwed into a threaded hole in the center of a serving bowl. Depending upon the degree to which the bowl is threaded into the serving bowl, water will either remain in the serving bowl or drain through the colander and channels in its threaded base out through the serving bowl. While the Donohue device is similar in nature and pursues the same goals, the present invention is comprised of fewer large parts, simplifying cleaning. Additionally, food product straining often separates particles of numerous sizes that can foul an internally threaded strainer, preventing a complete seal.

U.S. Patent Application Publication No. 2005/0205487 to Rogers presents a multipart seasoning apparatus that is comprised of a large bowl with an integrated strainer placed at the top, and caps for the openings at the top and bottom, and a plurality of mating lids for the caps to provide separate storage before and after preparation. An alternative embodiment includes a rotating bar handle and spring biased support base to induce rotation. Though Rogers pursues the same goals, the present invention presents fewer parts, requires less storage, and can be easily cleaned. Additionally, the much lower location of the strainer in the present invention, allows a greater volume percentage to be utilized during the straining process.

The present invention is a new and improved strainer and bowl device providing storage or transportation of solid and/or liquid food products, which allows straining and drainage upon removal of the threaded base cap. The device is comprised of a generic bowl structure with an integrated strainer inset above a hollow base. The threaded base below the colander screen is a cylindrical shell, allowing liquid to drain through the colander screen inset at the base. In light of devices in the prior art, it is submitted that the present invention is substantially divergent in design elements from the prior art, and consequently it is clear that there is a need in the art for an improvement to multifunction strainer and bowl devices. In this regard the present invention substantially fulfills these needs.

### SUMMARY OF THE INVENTION

In view of the foregoing disadvantages inherent in the known types of colander and bowl apparatus now present in the prior art, the present invention provides a multifunction strainer and bowl wherein a single device may be used for washing, straining, storage, transportation and serving of food products without utilizing multiple nested structures.

It is another object of the present invention to provide a multifunction strainer and bowl apparatus that can change function by removal of a base cap and without removing any nested structure or interchanging elements for different functions.

Another object of the present invention is to provide a multifunction strainer and bowl apparatus that allows for storage and transport of food products within a sealed interior volume, whereby a sealing lid and threaded base cap enclose the bowl interior and prevent air and fluid penetration thereinto or therefrom.

Another object of the present invention is to provide a multifunction strainer and bowl apparatus that allows for washing and straining of food products when the lid and threaded base cap are removed, whereby a straining screen is positioned along the base of the bowl and allows water penetration therethrough when the base cap is removed from the bowl structure.

Yet another object of the present invention is to provide a multifunction strainer and bowl apparatus that allows for serving of food products after reapplication of the threaded base cap, whereby the assembly functions as a serving dish after use as a strainer or food storage device.

A final object of the present invention is to provide a multifunction strainer and bowl apparatus that functions as a kitchen dish that is simple to use, easy to clean, and robust and dependable for everyday use.

Other objects, features and advantages of the present invention will become apparent from the following detailed description taken in conjunction with the accompanying drawings.

### BRIEF DESCRIPTIONS OF THE DRAWINGS

Although the characteristic features of this invention will be particularly pointed out in the claims, the invention itself and manner in which it may be made and used may be better understood after a review of the following description, taken in connection with the accompanying drawings wherein like numeral annotations are provided throughout.

FIG. 1 shows an exploded perspective view of the major components of the multifunction strainer and bowl: the lid, bowl structure with colander screen and threaded base, and the bottom cap.

FIG. 2 shows a cross-section side view of the assembled device, wherein the bottom cap is threadably attached to the bowl structure to seal the device.

FIG. 3 shows a cross-section side view of the assembled device, wherein an embodiment of the bottom cap is threadably attached to the bowl structure to seal the device and to seal the strainer within the bowl.

FIG. 4 shows a top view of the device, demonstrating the screen inset within the base of the bowl.

FIG. 5 shows a bottom view of the device with the solid cap installed thereon.

### DETAILED DESCRIPTION OF THE INVENTION

Reference is made herein to the attached drawings. Like reference numerals are used throughout the drawings to depict like or similar elements of the multifunction strainer and bowl. For the purposes of presenting a brief and clear description of the present invention, the preferred embodiment will be discussed as used for straining, serving, or storing food products. The figures are intended for representative purposes only and should not be considered to be limiting in any respect.

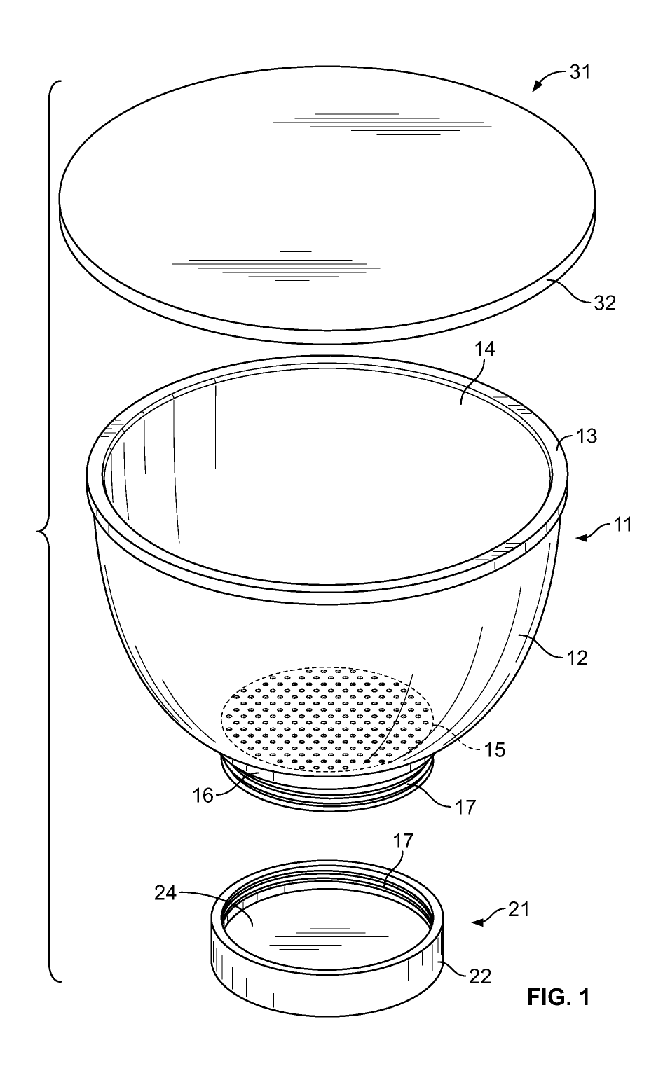

Referring now to FIG. 1, there is shown an exploded side view of the present invention. The primary elements of the device include the main bowl member 11, the threaded base cap 21, and the lid member 31. The main bowl member 11 contains an internal volume 14, which defines the storage capacity of the device. This internal volume 14 is bounded by upstanding sidewalls 12 that define the structure of the bowl 11 and its shape. The lower bound of the internal volume 14 and upstanding sidewalls 12 is an integrated strainer 15, which allows for continuous drainage of fluids from the internal volume 14. A threaded base member 16 is comprised of a cylindrical shell located below the strainer 15, which protrudes from the bowl lower and allows for stable positioning of the device on a flat surface. The base member 16 includes coupling threads 17 on its exterior to provide for a secure connection with a threaded base cap 21.

The threaded base cap 21 is comprised of a cylindrical shell body having a solid base 24 and upstanding sidewalls 22. The base sidewalls 22 include interior coupling threads 17 that match the coupling threads 17 on the main bowl member 11 threaded base member 16. The threaded base cap 21 includes a solid base 24 that prevents fluids drained through the bowl strainer 15 from leaving the device when the cap 21 is secured to the bowl threaded base 16.

Along the upper portion of the bowl 11 is a peripheral lip 13 that is adapted to provide securement of a lid member 31 thereover. The lid member 31 includes a corresponding lip 32 along its periphery to allow for a secure connection with the main bowl member lip 13. The lid member lip 32 attaches securely thereto, securing the entire upper circumference of the main bowl member 11 and preventing liquid or solid material from exiting the bowl 11 interior volume 14 when applied.

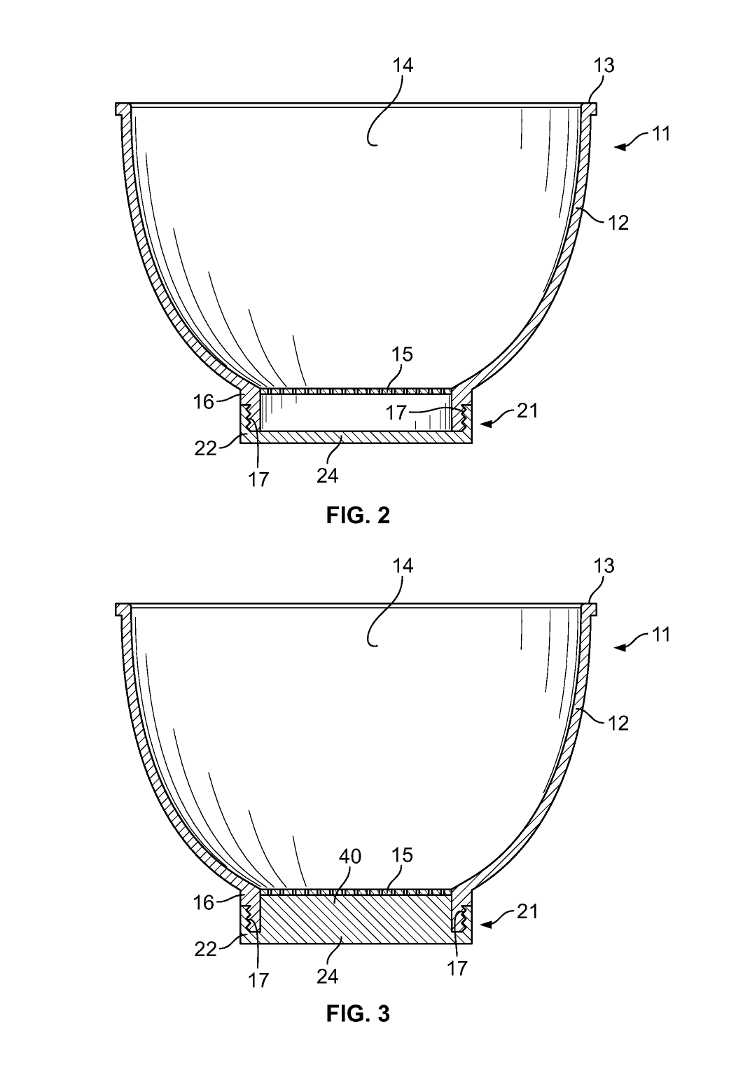

Referring now to FIG. 2, there is shown a cross sectional side view of the assembled device, demonstrating the secure attachment of the threaded base cap 21 with the bowl member 11 base member 16. Coupling threads 17 on the threaded base cap 21 extend a given length of the cap sidewalls 22 to allow the upper edge of the base cap 21 to seal flush against with the base member 16 of the bowl. The base member 16 and the base cap 21 share a corresponding pair of threads to allow smooth and repeated engagement over the life of the assembly. The cross sectional view also depicts the lip 13 along the upper portion of the bowl 11, which allows for attachment of a lid member (not shown) thereover. The upstanding sidewalls 12 of the bowl are also of a given design to establish an interior volume 14 sufficient for food preparation, storage, and serving, wherein fluid can be drained through the strainer screen 15 along the base of the interior volume 14 when the cap 21 is removed. When the cap 21 is applied, fluid will not pass through the base member 16 beyond the solid base 24 of the threaded cap 21.

Referring now to FIG. 3, there is shown a cross section view of an embodiment of the threaded base cap 21, wherein the cap 21 comprises an inner upstanding portion 40 that is adapted to make a flush connection against the base of the strainer 15 when the cap 21 is completely threaded onto the base member 16 of the bowl 11. In this embodiment, the inner portion of the cap 21 includes an upstanding region 40 that makes a seal against the base of the strainer 15 to prevent fluid and debris from accumulating within the otherwise open interior of the cap (FIG. 2). This embodiment is useful if a user wishes to use the bowl device when serving food, including liquid food products such as soup or means within gravies or other fluid media. The upstanding central portion 40 prevents leakage of the fluid through the strainer 15 while the bowl 21 is being used as a serving dish.

The embodiment of the present invention shown in FIG. 2 provides a the threaded cap 21 that threads over the exterior surface of the base member 16, wherein the base member 16 includes exterior threads 17 and the cap 21 includes interior threads 17. Also contemplated is an embodiment wherein the base member includes interior threads 17 and the cap 21 is provided having threads 17 that face outward (not shown). Both embodiments provide a threaded connection between the two elements and provide the same function with a slide design difference.

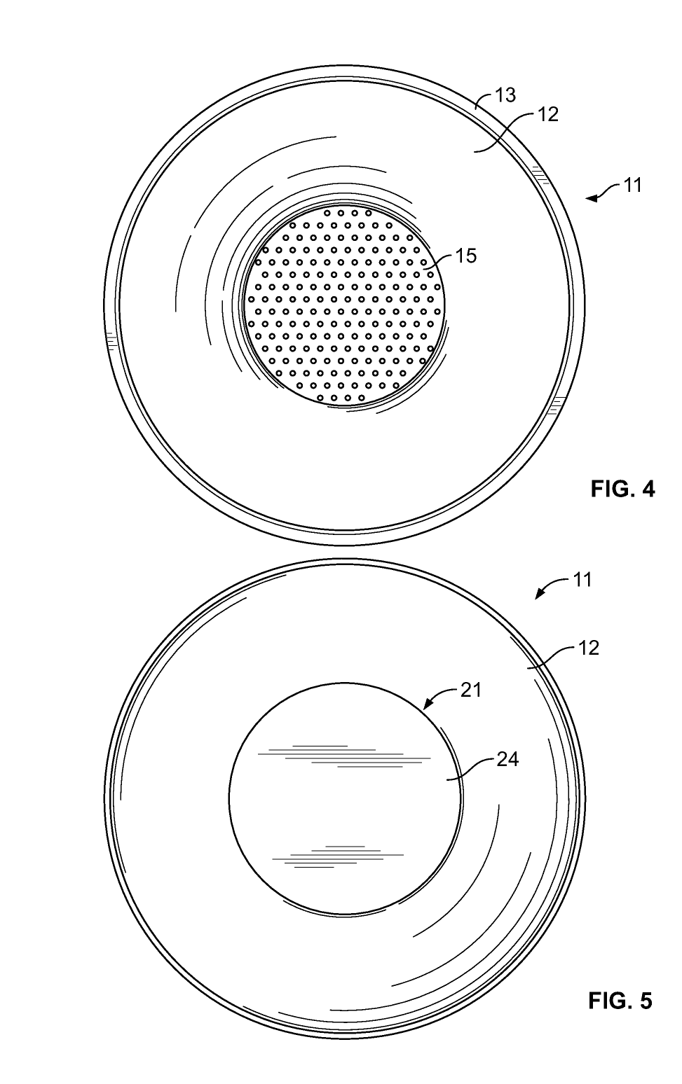

Referring now to FIG. 4, there is shown a top view of the present invention, demonstrating the interior bowl member 11 and the placement of the interior strainer 15 along its lower portion. FIG. 3 is shown with the bowl lid removed for the purposes of clarity. As shown, the strainer 15 comprises a planar or beveled surface along the lower portion of the bowl interior that comprises a plurality of apertures or a screened structure to allow for fluid to communicate therethrough and out through the base member of the bowl. The sidewalls 12 preferably provide an inherent curvature, as found in most bowls, which facilitates the flow of fluid towards the strainer 15 and therethrough. The strainer 15 may be an imbedded surface, or may also be a removable surface, whereby the strain 15 may be positioned within the bowl and operatively removed for cleaning purposes.

Referring now to FIG. 5, there is shown an underside view of the invention, demonstrating the attachment of the threaded base cap 21 to the bowl member 11. A volume of liquid and solid food can then be contained within the upstanding sidewalls 12 of the bowl, while the solid bottom 24 of the threaded base cap 21 prevents drainage through the base member when the cap is secured thereto. In this way, the device can function as a normal bowl for serving, food preparation, or food storage.

Overall, the present invention provides a convertible food preparation and food serving dish that allows a user to selectively store, serve, or strain food. The device comprises two primary elements: the bowl structure having a given geometry and material, along with a threaded base cap member that secures over the base member of the bowl structure. The design of the bowl, particularly its sidewall shape, extent, and the material thereof may take on several different embodiments, falling within the scope of the present invention. Likewise, the arrangement of the threaded cap and the disposition of the strainer may take several alternate forms and designs. Finally, it is contemplated that the bowl may be constructed of either a metallic or nonmetallic material, providing a convertible bowl that can be used for different purposes (e.g. high heat food products, long-term storage, etc.). It is not desired, however, to limit the present bowl structure to one specific material or one intended use, but rather it is desired to disclose a new and useful bowl and strainer device having the aforementioned elements.

It is therefore submitted that the instant invention has been shown and described in what is considered to be the most practical and preferred embodiments. It is recognized, however, that departures may be made within the scope of the invention and that obvious modifications will occur to a person skilled in the art. With respect to the above description then, it is to be realized that the optimum dimensional relationships for the parts of the invention, to include variations in size, materials, shape, form, function and manner of operation, assembly and use, are deemed readily apparent and obvious to one skilled in the art, and all equivalent relationships to those illustrated in the drawings and described in the specification are intended to be encompassed by the present invention.

Therefore, the foregoing is considered as illustrative only of the principles of the invention. Further, since numerous modifications and changes will readily occur to those skilled in the art, it is not desired to limit the invention to the exact construction and operation shown and described, and accordingly, all suitable modifications and equivalents may be resorted to, falling within the scope of the invention.

I claim:

1) A convertible strainer and container apparatus, comprising:
a container body structure having upstanding sidewalls forming an upper edge, a lower surface, and an open interior volume;
a hollow base member extending from said container lower surface and having an open lower;
said container base surface further comprising a plurality of apertures therethrough to allow communication of fluid from said interior volume into said hollow base member;
a removably attachable hollow base member cap for sealing said base member and preventing fluid communication therethrough.

2) The device of claim 1, wherein said apertured base surface is further removable from said container body structure to allow for cleaning thereof.

3) The device of claim 1, wherein said cap and hollow base member are threadably attached.

4) The device of claim 1, wherein said cap further comprises a lower surface and perimeter upstanding walls.

5) The device of claim 1, wherein:
said cap further comprises a lower surface and perimeter upstanding walls;
said cap perimeter upstanding walls further comprise internal threading
said hollow base member further comprises upstanding walls and external threading;
said cap internal threading and said base member external threading comprising an interface for removably attaching to said cap.

6) The device of claim 1, wherein:
said cap further comprises a lower surface and perimeter upstanding walls;
said cap perimeter upstanding walls further comprise external threading;
said hollow base member further comprises upstanding walls and internal threading;
said cap external threading and said base member internal threading comprising an interface for removably attaching to said cap.

7) The device of claim 1, further comprises a lid for securely sealing to said container structure upper edge.

8) The device of claim 1, wherein said cap further comprises an upstanding central portion that seals said apertured container base surface when said cap is attached to said base member, preventing fluid communication through said base surface.
